(19) United States
(12) Patent Application Publication
(10) Pub. No.: US 2020/0164957 A1
(43) Pub. Date: May 28, 2020

(54) UNMANNED AERIAL VEHICLE

(71) Applicant: SZ DJI TECHNOLOGY CO., LTD., Shenzhen (CN)

(72) Inventor: Zhenhua XU, Shenzhen (CN)

(21) Appl. No.: 16/748,998

(22) Filed: Jan. 22, 2020

Related U.S. Application Data
(63) Continuation of application No. PCT/CN2017/099700, filed on Aug. 30, 2017.

(51) Int. Cl. B64C 1/30; B64C 39/02; B64D 27/24; B64D 47/02; B64D 45/00; B60L 58/12; B64C 27/37

(52) U.S. Cl. CPC B64C 1/30; B64C 39/024; B64D 27/24; B64D 47/02; B64D 2045/0085; B60L 58/12; B64C 27/37; B64C 2201/027; B64C 2201/042; B64D 45/00

(57) ABSTRACT

An unmanned aerial vehicle includes a fuselage and a plurality of arm assemblies disposed at the fuselage. Each arm assembly includes an arm connected to the fuselage and a drive mechanism for driving the arm to rotate. The arm includes an unfolded state and a folded state. Each drive mechanism is configured to drive a corresponding arm to rotate relative to the fuselage and to enable a switching between the unfolded state and the folded state of the corresponding arm.

### CROSS-REFERENCE TO RELATED APPLICATION

This application is a continuation of International Application No. PCT/CN2017/099700, filed Aug. 30, 2017, the entire content of which is incorporated herein by reference.

### TECHNICAL FIELD

The present disclosure relates to the field of unmanned aerial vehicle technology and, more particularly, to a foldable unmanned aerial vehicle.

### BACKGROUND

Unmanned aerial vehicles are the most popular aerial photography and video tools, and more consumers choose the unmanned aerial vehicles for capturing photography and video. In order to meet user's portability requirements for the unmanned aerial vehicles, the unmanned aerial vehicles having foldable arms gradually emerge in the current market. The foldable unmanned aerial vehicles may have smaller sizes after the arms are retracted, which may occupy less space and be more portable for users.

However, in actual applications, existing unmanned aerial vehicles may require users to manually unfold or retract the arms to deploy or retrieve the unmanned aerial vehicles, which causes more complicated operation steps.

### SUMMARY

In accordance with the disclosure, an unmanned aerial vehicle is provided in the present disclosure. The unmanned aerial vehicle includes a fuselage and a plurality of arm assemblies disposed at the fuselage. Each arm assembly includes an arm connected to the fuselage and a drive mechanism for driving the arm to rotate. The arm includes an unfolded state and a folded state. Each drive mechanism is configured to drive a corresponding arm to rotate relative to the fuselage and to enable a switching between the unfolded state and the folded state of the corresponding arm.

### BRIEF DESCRIPTION OF THE DRAWINGS

In order to more clearly illustrate technical solutions in embodiments of the present disclosure, drawings required for describing the embodiments are briefly illustrated hereinafter. Obviously, the following drawings are merely examples for illustrative purposes according to various disclosed embodiments of the present disclosure and are not intended to limit the scope of the present disclosure. Those skilled in the art may obtain other drawings according to the drawings of the present disclosure without any creative efforts.

FIG. 1 illustrates a stereoscopic schematic of an unmanned aerial vehicle in a folded state according to various disclosed embodiments of the present disclosure;

FIG. 2 illustrates an exploded schematic of an unmanned aerial vehicle in FIG. 1;

FIG. 3 illustrates a stereoscopic schematic of an unmanned aerial vehicle in an unfolded state according to various disclosed embodiments of the present disclosure;

FIG. 4 illustrates a stereoscopic schematic of an unmanned aerial vehicle in an unfolding/folding process according to various disclosed embodiments of the present disclosure;

FIG. 5 illustrates an enlarged schematic of a portion A in FIG. 2;

FIG. 6 illustrates a bottom-view schematic of an unmanned aerial vehicle in FIG. 3;

FIG. 7 illustrates an enlarged schematic of a portion B in FIG. 6;

FIG. 8 illustrates an internal structural schematic of an unmanned aerial vehicle in FIG. 3;

FIG. 9 illustrates an enlarged schematic of a portion C in FIG. 8; and

FIGS. 10-11 illustrate connection schematics of an arm and a drive mechanism of an unmanned aerial vehicle according to various disclosed embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a part of the embodiments of the present disclosure, but not all embodiments. All other embodiments, based on the embodiments of the present disclosure, obtained by those skilled in the art without creative efforts are within the scope of the present disclosure.

Exemplary embodiments illustrated in the accompanying drawings are described in detail herein. When the accompanying drawings are described, same numerals in different drawings refer to same or similar elements unless otherwise indicated. The embodiment methods described in the following exemplary embodiments do not represent all embodiments consistent with the present disclosure. Instead, they are merely examples of devices and methods consistent with aspects of the disclosure as detailed in the appended claims.

The terminology used in the present disclosure is merely for the purpose of describing particular embodiments and is not intended to limit the disclosure. The singular forms “a”, “said”, and “the” used in the present disclosure and the appended claims may also include plural forms, unless the context clearly indicates other meanings. It should also be understood that the term “and/or” used in the present disclosure refers to and encompasses any and all possible combinations of one or more of associated listed items.

The present disclosure provides an unmanned aerial vehicle, which may include a fuselage and a plurality of arm assemblies disposed at the fuselage. For example, the plurality of arm assemblies may be disposed at an upper portion, a lower portion, a front portion, and/or a rear portion of a circumferential side of the fuselage. In some embodiments, the plurality of arm assemblies may be disposed on desired portion(s) of the circumferential side of the fuselage. Each arm assembly may include an arm connected to the fuselage and a drive mechanism for driving the arm to rotate. The arm may include an unfolded state and a folded state. The drive mechanism may drive a corresponding arm to rotate relative to the fuselage and enable the arm to switch between the unfolded state and the folded state. The unmanned aerial vehicle of the present disclosure may drive the arm to be unfolded or folded by the drive mechanism, thereby implementing the automatic unfolding or folding of the arm of the unmanned aerial vehicle, which may simplify user operation steps and be convenient for users.

The unmanned aerial vehicle of the present disclosure may be described in detail with reference to the drawings hereinafter. In case of no conflict, following embodiments and features of the embodiments may be combined with each other.

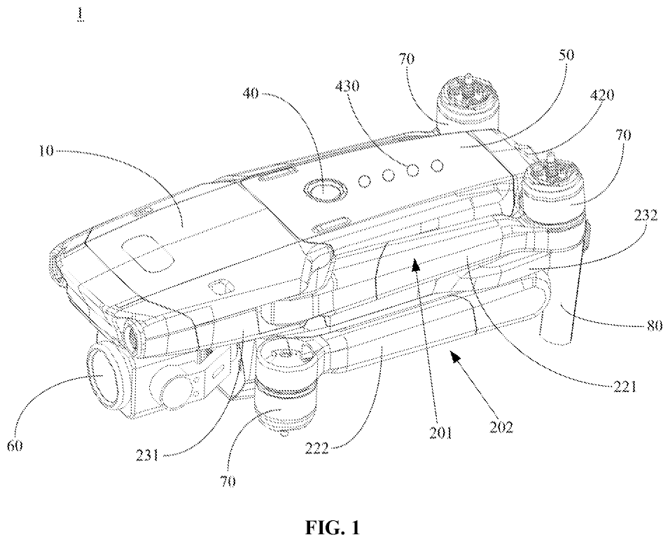

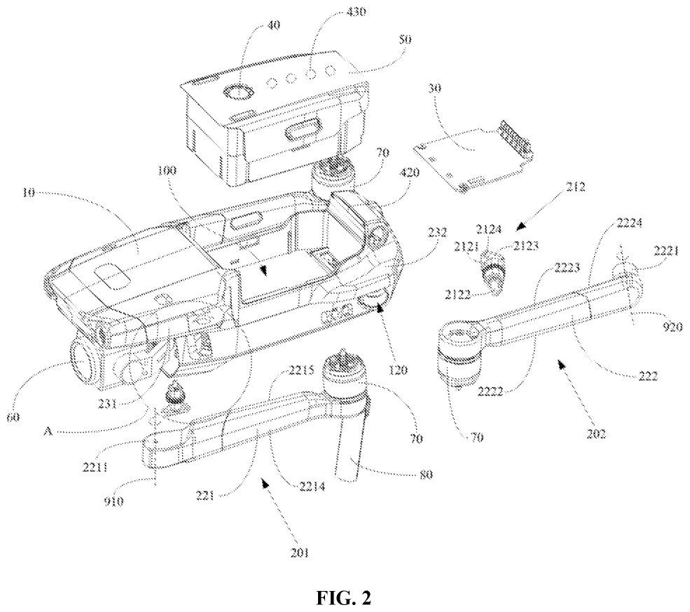

Referring to FIGS. 1-2, in one optional embodiment, an unmanned aerial vehicle 1 provided in the embodiments of the present disclosure may include a fuselage 10, a plurality of arm assemblies 201 and 202, a controller battery 50, and a gimbal camera 60. In one embodiment, the plurality of arm assemblies 201 and 202 may be disposed on a circumferential side of the fuselage 10.

An accommodation trench 100 may be disposed on a top of the fuselage 10. The battery 50 may be at least partially disposed in the accommodation trench 100. For example, the battery 50 may be partially or wholly disposed in the accommodation trench 100. The battery 50 may be electrically connected to a controller for supplying power to the controller. The controller may be disposed on a motor board 30, and the motor board 30 may be disposed in the accommodation trench 100 and attached to a bottom of the battery 50. A heat dissipation plate may be disposed at a bottom of the accommodation trench 100. The heat dissipation plate may be attached to the motor board 30 to dissipate heat for the motor board 30.

The gimbal camera 60 may be disposed at a front of the fuselage 10. The gimbal camera 60 may include a gimbal bracket and a camera mounted on the gimbal bracket. Optionally, the gimbal bracket may be a three-axis gimbal bracket. The gimbal bracket may include a yaw axis assembly, a roll axis assembly movably connected to the yaw axis assembly, and a pitch axis assembly movably connected to the roll axis assembly. The camera may be mounted on the pitch axis assembly.

The arm assemblies 201 and 202 may include arms 221 and 222 connected to the fuselage 10, drive mechanisms 211 and 212, and propeller assemblies. The drive mechanisms 211 and 212 may be electrically connected to the controller and be capable of driving the corresponding arms 221 and 222 to rotate relative to the fuselage 10, thereby implementing the portability of the foldable arms of the unmanned aerial vehicle 1. The propeller assemblies may include motors 70 disposed at the arms 221 and 222, and propellers (not shown) connected to the motors 70, and the motors 70 may drive the propellers to rotate, thereby implementing the flight function of the unmanned aerial vehicle 1. In one embodiment, the drive mechanisms 211 and 212 may be disposed at ends of arms 221 and 222; the motors 70 of the propeller assemblies may be disposed at ends of the arms 221 and 222 away from the drive mechanisms 211 and 212; and the arms 221 and 222 may be connected to the fuselage 10 through the corresponding drive mechanisms 211 and 212.

Referring to FIGS. 1-3, head indicator lights 410 configured for indicating a head direction of the unmanned aerial vehicle, status indicator lights 420 configured for indicating an unmanned aerial vehicle status, and battery level indicator lights 430 configured for indicating a level of the battery 50 may be disposed on the fuselage 10. Optionally, the light-emitting diode (LED) indicator lights may be used for the head indicator lights 410, the status indicator lights 420 and the battery level indicator lights 430.

In the embodiments shown in FIGS. 1-3, the head indicator lights 410 may be disposed on the arms 221 and 222 at the front of the fuselage 10 for indicating the head direction of the unmanned aerial vehicle, and may display a solid red when the unmanned aerial vehicle is turned on, which is convenient for the user to identify the unmanned aerial vehicle. The battery level indicator lights 430 may be disposed on the battery 50 and a quantity of the battery level indicator lights 430 is four. The more the quantity of turned-on battery level indicator lights 410 is, the higher the battery level of the battery 50 is.

The status indicator 420 may be disposed at a rear portion of the fuselage 10 to indicate a current status of the unmanned aerial vehicle. The unmanned aerial vehicle may be used with a remote control. A GPS positioning system, a vision system, an alarm system, a sensor, a compass and the like may be disposed inside the unmanned aerial vehicle. The status indicator lights 420 may flash different colors to indicate different statuses of the unmanned aerial vehicle. For example, when the status indicator lights 420 flash red, green and yellow continuously, it may indicate self-diagnostic testing; when the status indicator lights 420 flash alternating yellow and green, it may indicate warming up; when the status indicator lights 420 flash green slowly, it may indicate using the GPS positioning; when the status indicator lights 420 have two green flashing, it may indicate using the vision system; when the status indicator lights 420 flash yellow slowly, it may indicate no GPS and no vision system; when the status indicator lights 420 flash green fast, it may indicate braking; when the status indicator lights 420 flash yellow fast, it may indicate remote controller signal lost; when the status indicator lights 420 flash red slowly, it may indicate low battery warning; when the status indicator lights 420 flash red fast, it may indicate critical low battery warning; when the status indicator lights 420 flash alternating red, it may indicate uneven placement or large sensor error; when the status indicator lights 420 flash solid red, it may indicate critical error; and when the status indicator lights 420 flash alternating red and yellow, it may indicate compass calibration required.

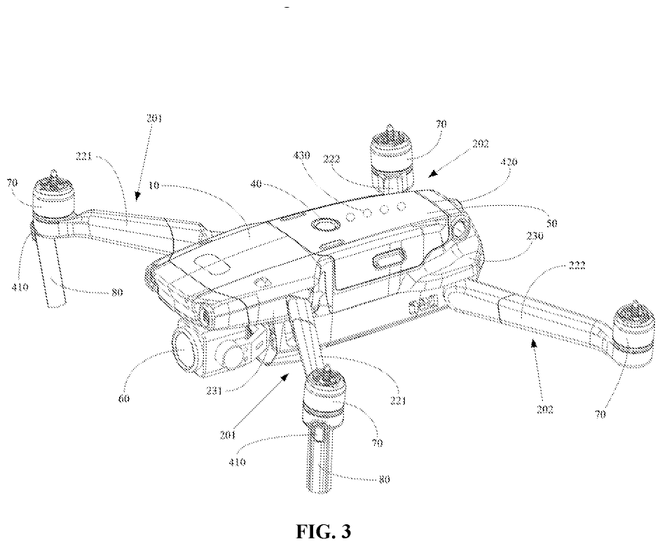

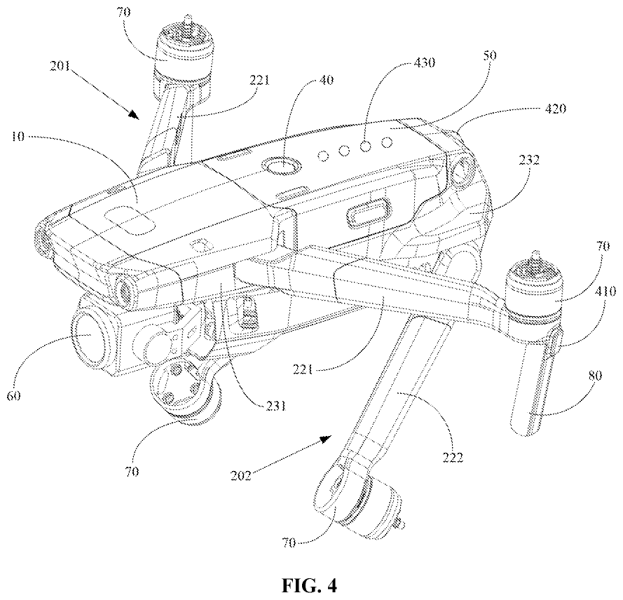

Referring to FIGS. 1-3, the arms 221 and 222 may include the unfolded state and the folded state. When the unmanned aerial vehicle is not in operation, the arms 221 and 222 may be in the folded state, and each of the arms 221 and 222 may be folded and attached to a circumferential side of the fuselage 10, as shown in FIG. 1. When the unmanned aerial vehicle is in operation, the arms 221 and 222 may be in the unfolded state, and each of the arms 221 and 222 may be fully unfolded relative to the fuselage 10, as shown in FIG. 3. The controller may be configured to transmit control signals to the drive mechanisms 211 and 212 to drive the corresponding arms 221 and 222 to rotate relative to the fuselage, thereby implementing the switching of the arms 221 and 222 between the unfolded state and the folded state. Referring to FIG. 4, when the arms 221 and 222 are rotated from the folded state to the unfolded state, each of the arms 221 and 222 may first be rotated from the position where each arm is folded and attached to the circumferential side of the fuselage 10 shown in FIG. 1 to an intermediate position shown in FIG. 4 along a direction away from the fuselage 10, and then be rotated gradually to the fully unfolded position relative to the fuselage 10 shown in FIG. 3. When the arms 221 and 222 are rotated from the unfolded state to the folded state, each of the arms 221 and 222 may first be rotated from the fully unfolded position relative to the fuselage 10 shown in FIG. 3 to the intermediate position shown in FIG. 4 along a direction close to the fuselage 10, and then be rotated gradually to the position where each arm is folded and attached to the circumferential side of the fuselage 10 shown in FIG. 1.

It can be seen from the above-mentioned embodiments that the unmanned aerial vehicle 1 of the present disclosure may transmit control signals to the drive mechanisms 211 and 212 through the controller, and the corresponding arms 221 and 222 may be driven to be unfolded or folded by the drive mechanisms 211 and 212, thereby implementing the automatic unfolding and folding of the arms 221 and 222 of the unmanned aerial vehicle 1. In such way, the enjoyment and intelligence level of using products may be increased; the user operation steps may be simplified; and the user operation may be more convenient, thereby improving the user experience and the product market competitiveness.

In an optional embodiment, the control signals transmitted by the controller to the drive mechanisms 211 and 212 may include a first signal for controlling the drive mechanisms 211 and 212 to rotate along a first direction, thereby driving the corresponding arms 221 and 222 to rotate along the first direction by the drive mechanisms 211 and 212. In one embodiment, the rotation of the arms 221 and 222 along the first direction driven by the drive mechanisms 211 and 212 may refer to that the arms 221 and 222 are rotated from the folded state to the unfolded state, that is, the drive mechanisms 211 and 212 may drive the arms 221 and 222 to rotate along the direction away from the fuselage 10. After the user turns on the unmanned aerial vehicle 1 and completes the aircraft detection successfully, the controller may synchronously transmit the first signal to the respective drive mechanisms 211 and 212 of the plurality of arm assemblies 201 and 202, so the respective drive mechanisms 211 and 212 of the plurality of arm assemblies 201 and 202 may drive the corresponding arms 221 and 222 to synchronously rotate relative to the fuselage to the unfolded state.

In an optional embodiment, the control signals transmitted by the controller to the drive mechanisms 211 and 212 may include a second signal for controlling the drive mechanisms 211 and 212 to rotate along a second direction, thereby driving the corresponding arms 221 and 222 to rotate along the second direction by the drive mechanisms 211 and 212, where the second direction may be opposite to the first direction. In one embodiment, the rotation of the arms 221 and 222 along the second direction driven by the drive mechanisms 211 and 212 may refer to that the arms 221 and 222 are rotated from the unfolded state to the folded state, that is, the drive mechanisms 211 and 212 may drive the arms 221 and 222 to rotate along the direction close to the fuselage 10. After the user turns off the unmanned aerial vehicle 1 and completes the aircraft detection successfully, the controller may synchronously transmit the second signal to the respective drive mechanisms 211 and 212 of the plurality of arm assemblies 201 and 202, so the respective drive mechanisms 211 and 212 of the plurality of arm assemblies 201 and 202 may drive the corresponding arms 221 and 222 to synchronously rotate relative to the fuselage to the folded state.

In an optional embodiment, the unmanned aerial vehicle 1 may further include a power button 40. The power button 40 may be disposed on the battery 50 and electrically connected to the controller. When the user presses the power button 40 to turn on the unmanned aerial vehicle 1, and the respective drive mechanisms 211 and 212 of the plurality of arm assemblies 201 and 202 may drive the corresponding arms 211 and 212 to be unfolded till rotating to the unfolded state. When the user presses the power button 40 to turn off the unmanned aerial vehicle 1, and the respective drive mechanisms 211 and 212 of the plurality of arm assemblies 201 and 202 may drive the corresponding arms 211 and 212 to be folded till rotating to the folded state.

In an optional embodiment, the arm assemblies 201 and 202 may further include stopping portions 231 and 232. The stopping portions 231 and 232 may be disposed at the fuselage 10 along a rotation direction of the arms 221 and 222. In some embodiments, the stopping portions 231 and 232 may be disposed on the fuselage 10. The rotation direction may refer to a direction of the arms 221 and 222 from the folded state to the unfolded state. When the arms 221 and 222 rotate from the folded state to the unfolded state, the arms 221 and 222 may abut against the stopping portions 231 and 232, and the stopping portions 231 and 232 may limit positions of the arms 221 and 222. When the arms 221 and 222 rotate from the unfolded state to the folded state, the arms 221 and 222 may attach to the fuselage 10.

Furthermore, the control signals transmitted by the controller to the drive mechanisms 211 and 212 may include a third signal for controlling the drive mechanisms 211 and 212 to continuously rotate along the first direction, so the drive mechanisms 211 and 212 may drive the corresponding arms 221 and 222 to continuously rotate along the first direction. When the arms 221 and 222 are in the unfolded state, the controller may transmit the third signal to the respective drive mechanisms 211 and 212 of the plurality of arm assemblies 201 and 202, so the mechanisms 211 and 212 of the plurality of arm assemblies 201 and 202 may drive the corresponding arms 221 and 222 to abut against the stopping portions 231 and 232 with a continuous drive force. That is, after the arms 221 and 222 are rotated to the unfolded state, the arms 221 and 222 may be stopped by the stopping portions 231 and 232, but the battery 50 may continue to supply power to the drive mechanisms 211 and 212 to provide a certain torque to maintain the unfolding torque of the arms 221 and 222. In such way, the situation that folding the arms 221 and 222 of the unmanned aerial vehicle 1 during flight or being hit may be avoided; and until the user presses the power button 40 to turn off the unmanned aerial vehicle 1, the controller may transmit the second signal to the drive mechanisms 211 and 212, thereby driving the corresponding arms 221 and 222 to be folded by the drive mechanisms 211 and 212.

In an optional embodiment, the unmanned aerial vehicle 1 may be a multiple propeller unmanned aerial vehicle. The plurality of arm assemblies 201 and 202 may include at least two first arm assemblies 201 and at least two second arm assemblies 202. The at least two first arm assemblies 201 may be disposed at the front portion of the fuselage 10, and the at least two second arm assemblies 202 may be disposed at the rear portion of the fuselage 10.

A quad-propeller unmanned aerial vehicle may be used as an example of the unmanned aerial vehicle 1 to describe the unmanned aerial vehicle 1 of the present disclosure in detail hereinafter. The quantity of the first arm assemblies 201 may be two, and the first arm assemblies 201 may be disposed on two sides of the front portion of the fuselage 10. The quantity of the second arm assemblies 202 may be two, and the second arm assemblies 202 may be disposed on two sides of the rear portion of the fuselage 10.

The first arm assembly 201 may include a first drive mechanism 211 disposed at the front portion of the fuselage 10, a first arm 221 connected to the first drive mechanism 211, and a first stopping portion 231 disposed at the fuselage 10 (e.g., disposed on the fuselage 10) along the rotation direction of the first arm 221. The first drive mechanism 211 may be connected to the controller, and the controller may transmit the control signals to the first drive mechanism 211 to drive the first arm 221 to rotate relative to the fuselage 10 by the first drive mechanism 211. In one embodiment, for the first arm assembly 201, the first drive mechanism 221 may be perpendicularly connected to the first arm 211, and the controller may control the first drive mechanism 211 of the first arm assembly 201 to rotate along a vertical direction 910, thereby driving the first arm 221 to rotate along the vertical direction 910 relative to the fuselage 10 by the first drive mechanism 211, that is, the first drive mechanism 211 may drive the first arm 221 to be folded back and forth relative to the fuselage 10.

The second arm assembly 202 may include a second drive mechanism 212 disposed at the rear portion of the fuselage 10, a second arm 222 connected to the second drive mechanism 212, and a second stopping portion 232 disposed at the fuselage 10 (e.g., disposed on the fuselage 10) along the rotation direction of the second arm 222. The second drive mechanism 212 may be connected to the controller, and the controller may transmit the control signals to the second drive mechanism 212 to drive the second arm 222 to rotate relative to the fuselage 10 by the second drive mechanism 212. In one embodiment, for the second arm assembly 202, the second drive mechanism 222 and the second arm 212 may be connected in a tilted direction (e.g., a non-vertical direction or a non-horizontal direction), and the controller may control the second drive mechanism 212 of the second arm assembly 202 to rotate along a horizontal direction 920, thereby driving the second arm 222 to rotate along the horizontal direction 920 relative to the fuselage 10 by the second drive mechanism 212, that is, the second drive mechanism 212 may drive the second arm 222 to be folded up and down relative to the fuselage 10.

Furthermore, a stand 80, used for take-off and landing of the unmanned aerial vehicle 1, may be disposed at the bottom of one end of the first arm 221 of the first arm assembly 201 having the motor. In order to prevent the first arm 221 and the second arm 222 from being unable to be unfolded or folded normally during the unfolding or folding process due to the impact of the stand 80, the controller may transmit control signals to the first drive mechanism 211 and the second drive mechanism 212 according to a specified sequence, so the first arm 221 and the second arm 222 may be sequentially unfolded or folded according to the specified sequence.

After the user turns on the unmanned aerial vehicle 1 and completes the aircraft detection successfully, the controller may sequentially transmit the first signal to the first drive mechanism 211 and the second drive mechanism 212 according a first sequence, so the first arm 221 and the second arm 222 may be sequentially rotated to the unfolded state. In one embodiment, the first sequence may refer to that the controller first transmits the control signal to the first drive mechanism 211 and then transmits the control signal to the second drive mechanism 212. That is, the controller may first transmit the first signal to the first drive mechanism 211 and then transmit the first signal to the second drive mechanism 212, so the first drive mechanism 211 may first drive the first arm 221 to be unfolded, and then the second drive mechanism 212 may drive the second arm 222 to be unfolded. In such way, the situation that the first arm 221 may not be unfolded normally because the stand 80 is blocked by the second arm 222 after the second arm 222 is unfolded before the first arm 221 may be prevented.

After the user turns off the unmanned aerial vehicle 1 and completes the aircraft detection successfully, the controller may sequentially transmit the second signal to the first drive mechanism 211 and the second drive mechanism 212 according a second sequence, so the first arm 221 and the second arm 222 may be sequentially rotated to the folded state, where the second sequence may be opposite to the first sequence. In one embodiment, the second sequence may refer to that the controller first transmits the control signal to the second drive mechanism 212 and then transmits the control signal to the first drive mechanism 211. That is, the controller may first transmit the second signal to the second drive mechanism 212 and then transmit the second signal to the first drive mechanism 211, so the second drive mechanism 212 may first drive the second arm 222 to be unfolded, and then the first drive mechanism 211 may drive the first arm 221 to be unfolded. In such way, the situation that the first arm 221 may not be folded normally because the stand 80 is blocked by the second arm 222 after the first arm 221 is folded before the second arm 222 may be prevented.

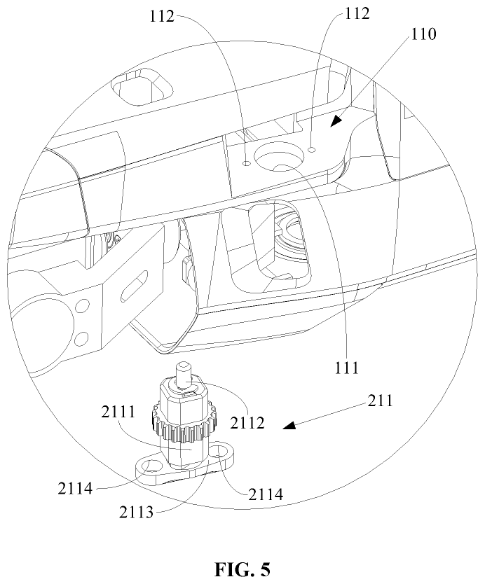

In an optional embodiment, referring to FIG. 5, a first accommodation portion 110 may be disposed at a front side portion of the fuselage 10. The first drive mechanism 211 of the first arm assembly 201 may be at least partially disposed in the first accommodation portion 100 along the vertical direction 910. The first stopping portion 231 of the first arm assembly 201 may be formed by a portion of the fuselage 10 which may be located in the front of the first accommodation portion 110 and be adjoined to the first accommodation portion 110. Referring to FIG. 2, a second accommodation portion 120 may be disposed at a rear side portion of the fuselage 10. The second drive mechanism 212 of the second arm assembly 202 may be at least partially disposed in the second accommodation portion 120 along the horizontal direction. The second stopping portion 232 of the second arm assembly 202 may be formed by outwardly extending a portion of the fuselage above the second accommodation portion 120.

Furthermore, the first arm 221 may include a first sidewall and a second sidewall, configured opposite to each other. A first abutting portion 2214 may be disposed at the first sidewall of the first arm 221, and a first attaching portion 2215 may be disposed at the second sidewall of the first arm 221. When the first arm 221 is rotated to the unfolded state, the first abutting portion 2214 may abut against the first stopping portion 231. When the first arm 221 is rotated to the folded state, the first attaching portion 2215 may attach to the fuselage 10. The second arm 222 may include a first sidewall and a second sidewall, configured opposite to each other. A second abutting portion 2222 may be disposed at the first sidewall of the second arm 222, and a third abutting portion 2223 may be disposed at the second sidewall of the second arm 222. A second attaching portion 2224 may be disposed at a third sidewall which is between the first sidewall and the second sidewall of the second arm 222 and adjacent to the fuselage 10. When the second arm 222 is rotated to the unfolded state, the second abutting portion 2222 may abut against the second stopping portion 232. When the second arm 222 is rotated to the folded state, the third abutting portion 2223 may abut against the second stopping portion 232, and the second attaching portion 2224 may attach to the fuselage 10.

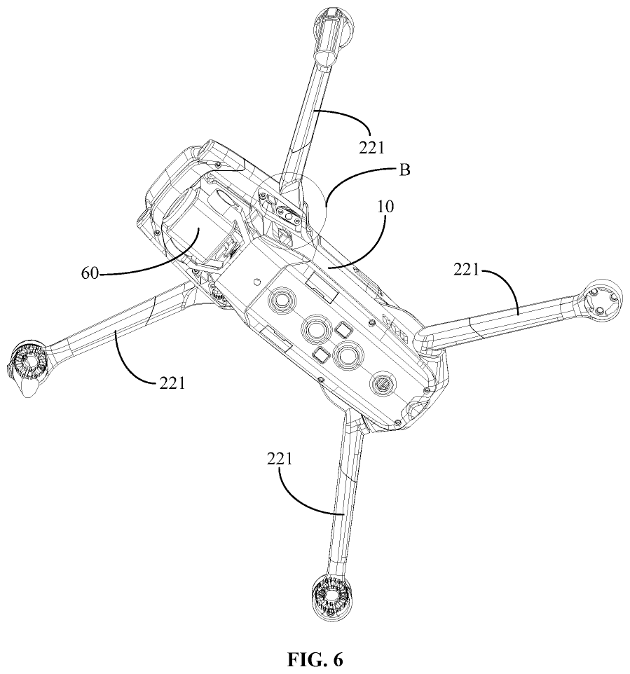

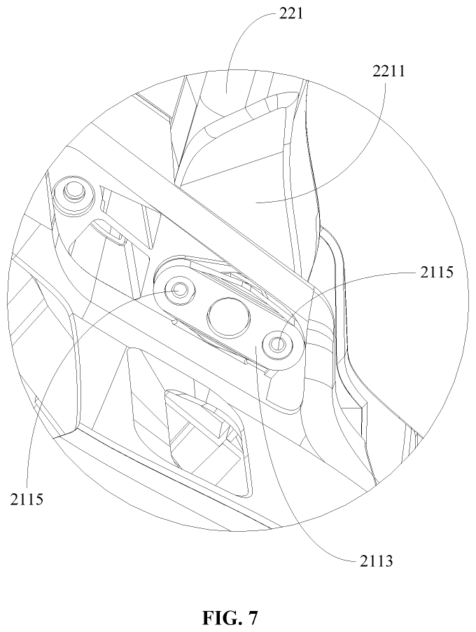

In an optional embodiment, referring to FIG. 2, the first drive mechanism 211 may be a drive motor; a first mounting portion 2211 may be disposed at the end of the first arm 221; and the first mounting portion 2211 may be at least partially disposed in the first accommodation portion 110 and connected to the first drive mechanism 211. Further, referring to FIG. 5, the first drive mechanism 211 may include a first motor main body 2111, and a first drive axle 2112 and a first mounting plate 2113 disposed at two ends of the first motor main body 2111; the first mounting plate 2113 may be fixed to the sidewall of the first accommodation portion 110; and the first drive axle 2112 may extend along the vertical direction 910 and be fixed to the first mounting portion 2211. A first through hole 111 and first mounting holes 112 may be disposed at the sidewall of the first accommodation portion 110. First connecting holes 2114 corresponding to the first mounting holes 112 may be disposed on the first mounting plate 2113. Referring to FIGS. 6-7, the first motor main body 2111 may be disposed through the first through hole 111, and the first mounting plate 2113 may be fixed to the sidewall of the first accommodation portion 110 through a first fastener 2115 (e.g., a bold) which is disposed through the first connecting hole 2114 and the first mounting hole 112. Of course, the first through hole 111 may not be disposed at the sidewall of the first accommodation portion 110, and the first motor main body 2111 may be fixed to the sidewall of the first accommodation portion 110 through the first fastener 2115.

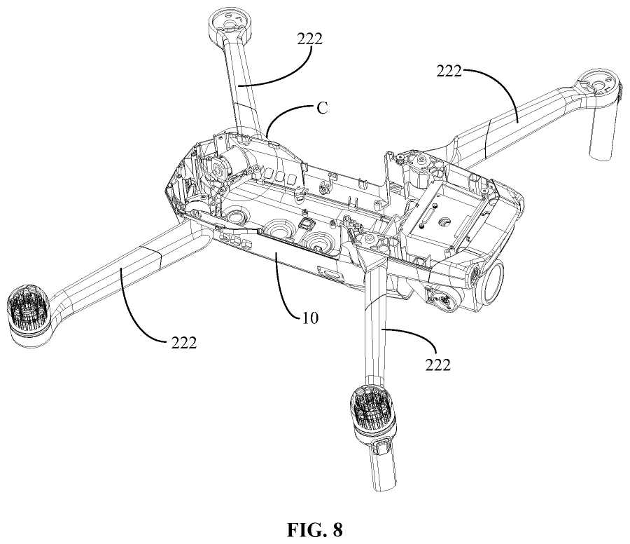

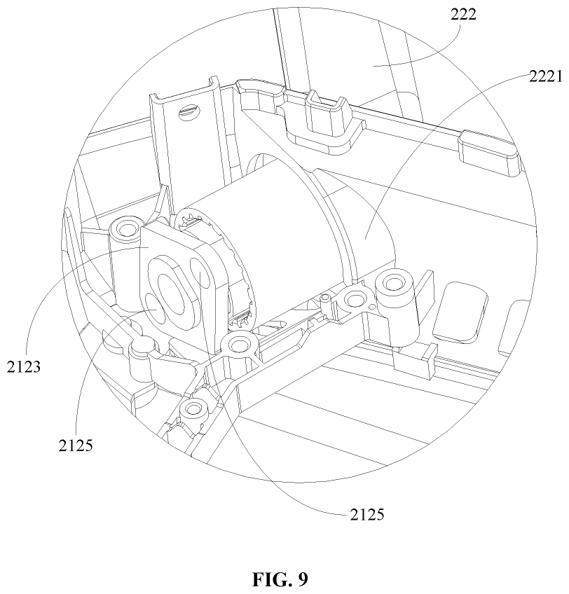

Referring to FIG. 2, the second drive mechanism 212 may be a drive motor; a second mounting portion 2221 may be disposed at the end of the second arm 222; and the second mounting portion 2221 may be at least partially disposed in the second accommodation portion 120 and connected to the second drive mechanism 212. Further, the second drive mechanism 212 may include a second motor main body 2121 and a second drive axle 2122 and a second mounting plate 2123 disposed at two ends of the second motor main body 2121; the second mounting plate 2123 may be fixed to the bottom wall of the second accommodation portion 120; and the second drive axle 2122 may extend along the horizontal direction 920 and be fixed to the second mounting portion 2221. A second through hole 121 and second mounting holes 122 may be disposed at the sidewall of the second accommodation portion 120. Second connecting holes 2124 corresponding to the second mounting holes 122 may be disposed on the second mounting plate 2123. Referring to FIGS. 8-9, the second motor main body 2121 may be disposed through the second through hole 121, and the second mounting plate 2123 may be fixed to the bottom wall of the second accommodation portion 120 through a second fastener 2125 (e.g., a bold) which is disposed through the second connecting hole 2124 and the second mounting hole 122. Of course, the second through hole 121 may not be disposed at the bottom wall of the second accommodation portion 120, and the second motor main body 2121 may be fixed to the bottom wall of the second accommodation portion 120 through the second fastener 2125.

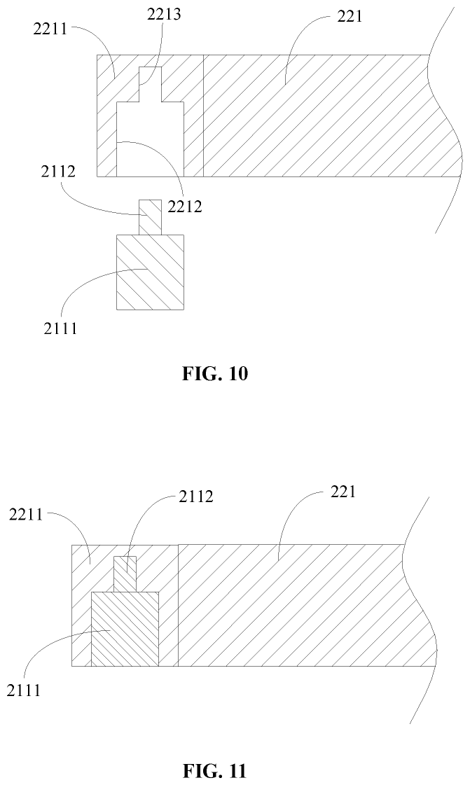

Referring to FIGS. 10-11, a first accommodation cavity 2212 matching the first motor main body 2111 may be disposed in the first mounting portion 2211 of the first arm 221, and a second accommodation cavity 2213 matching the first drive axle 2112 may be disposed at the bottom wall of the first accommodation cavity 2212. The first motor main body 2111 may be accommodated in the first accommodation cavity 2212, and the first drive axle 2112 may be accommodated in the second accommodation cavity 2213 and fixed to the first mounting portion 2211. In such way, the appearance of the first drive mechanism 211 and the first arm 221 may be flat to save space. Similarly, a third accommodation cavity (not shown) matching the second motor main body 2121 may be disposed in the second mounting portion 2221 of the second arm 222, and a fourth accommodation cavity (not shown) matching the second drive axle 2122 may be disposed at the bottom wall of the second accommodation cavity 2212. The second motor main body 2121 may be accommodated in the third accommodation cavity, and the second drive axle 2122 may be accommodated in the fourth accommodation cavity and fixed to the second mounting portion 2221. In such way, the appearance of the second drive mechanism 212 and the second arm 221 may be flat to save space.

It should be noted that, in the present disclosure, relationship terms such as first, second and the like are merely used to distinguish one entity or operation from another entity or operation, and do not necessarily require or imply any such relationship or sequence between the entities or operations. The terms “including”, “comprising” or other variants thereof are intended to encompass non-exclusive inclusions, so a process, a method, an item or an device including a series of elements may include such elements, but also include other elements which are not explicitly listed, or include elements which are inherent to the process, the method, the item, or the device. Without additional restrictions, elements defined by the phrase “include a . . . ” does not exclude the presence of additional same elements in the process, the method, the item, or the device including the series of elements.

The unmanned aerial vehicle provided by the embodiments of the present disclosure is described in detail above. The principles and embodiment methods of the present disclosure are described with reference to specific examples, and the description of the above-mentioned embodiments is merely for understanding the essential concept of the present disclosure. Meanwhile, the implementation manner and application scope may be changed by those skilled in the art according to the concept of the present disclosure. The contents of the specification should not be construed as limiting the scope of the disclosure.

What is claimed is:

1. An unmanned aerial vehicle, comprising:
a fuselage and a plurality of arm assemblies disposed at the fuselage, wherein:
each arm assembly includes an arm connected to the fuselage and a drive mechanism for driving the arm to rotate;
the arm includes an unfolded state and a folded state; and
each drive mechanism is configured to drive a corresponding arm to rotate relative to the fuselage and to enable a switching between the unfolded state and the folded state of the corresponding arm.

2. The unmanned aerial vehicle according to claim 1, further including:
a controller connected to each drive mechanism, wherein the controller is configured to transmit control signals to the drive mechanism to drive the corresponding arm to rotate relative to the fuselage.

3. The unmanned aerial vehicle according to claim 2, wherein:
the control signals include a first signal for controlling the drive mechanism to rotate along a first direction; and
when the unmanned aerial vehicle is turned on, the controller is configured to synchronously transmit the first signal to respective drive mechanisms of the plurality of arm assemblies to drive the respective arms of the plurality of arm assemblies to synchronously rotate to the unfolded state relative to the fuselage.

4. The unmanned aerial vehicle according to claim 3, wherein:
the control signals include a second signal for controlling the drive mechanism to rotate along a second direction, wherein the second direction is opposite to the first direction; and
when the unmanned aerial vehicle is turned off, the controller is configured to synchronously transmit the second signal to respective drive mechanisms of the plurality of arm assemblies to drive the respective arms of the plurality of arm assemblies to synchronously rotate to the folded state relative to the fuselage.

5. The unmanned aerial vehicle according to claim 2, wherein:
each arm assembly further includes a stopping portion, and the stopping portion is disposed at the fuselage along a rotation direction of the arm; and
when the arm is at the unfolded state, the arm is configured to abut against the stopping portion, and when the arm is at the folded state, the arm is configured to attach to the fuselage.

6. The unmanned aerial vehicle according to claim 5, wherein:
the control signals include a third signal for controlling the drive mechanism to continuously rotate along a first direction; and
when the arm is at the unfolded state, the controller is configured to transmit the third signal to the drive mechanism to drive the arm to abut against the stopping portion with a continuous drive force.

7. The unmanned aerial vehicle according to claim 5, wherein:
the plurality of arm assemblies includes at least two first arm assemblies and at least two second arm assemblies; and
the at least two first arm assemblies are disposed at a front portion of the fuselage and the at least two second arm assemblies are disposed at a rear portion of the fuselage.

8. The unmanned aerial vehicle according to claim 7, wherein:
the control signals include a first signal for controlling the drive mechanism of the first arm assembly and the drive mechanism of the second assembly to rotate along a first direction; and
when the unmanned aerial vehicle is turned on, the controller is configured to sequentially transmit the first signal to the drive mechanism of the first arm assembly and the drive mechanism of the second assembly according to a first sequence to drive the arm of the first arm assembly and the arm of the second arm assembly to rotate sequentially to the unfolded state.

9. The unmanned aerial vehicle according to claim 8, wherein:
the control signals include a second signal for controlling the drive mechanism of the first arm assembly and the drive mechanism of the second assembly to rotate along a second direction, wherein the second direction is opposite to the first direction; and
when the unmanned aerial vehicle is turned off, the controller is configured to sequentially transmit the second signal to the drive mechanism of the first arm assembly and the drive mechanism of the second assembly according to a second sequence to drive the arm of the first arm assembly and the arm of the second arm assembly to rotate sequentially to the folded state, wherein the second sequence is opposite to the first sequence.

10. The unmanned aerial vehicle according to claim 9, wherein:
the first sequence refers to that the controller is configured to first transmit the control signals to the drive mechanism of the first arm assembly and then transmit the control signals to the drive mechanism of the second arm assembly; and
the second sequence refers to that the controller is configured to first transmit the control signals to the drive mechanism of the second arm assembly and then transmit the control signals to the drive mechanism of the first arm assembly.

11. The unmanned aerial vehicle according to claim 7, wherein:
the drive mechanism and the arm of the first arm assembly are connected in a perpendicular direction, and the controller is configured to control the drive mechanism of the first arm assembly to rotate along a vertical direction; and
the drive mechanism and the arm of the second arm assembly are connected in a tilted direction, and the controller is configured to control the drive mechanism of the second arm assembly to rotate along a horizontal direction.

12. The unmanned aerial vehicle according to claim 11, wherein:
a first accommodation portion is disposed at a front side portion of the fuselage; the drive mechanism of the first arm assembly is at least partially disposed in the first accommodation portion; and a stopping portion of the first arm assembly is formed by a portion of the fuselage which is located in a front of the first accommodation portion and is adjoined to the first accommodation portion; and
a second accommodation portion is disposed at a rear side portion of the fuselage; the drive mechanism of the second arm assembly is at least partially disposed in the second accommodation portion; and a stopping portion of the second arm assembly is formed by outwardly extending a portion of the fuselage above the second accommodation portion.

13. The unmanned aerial vehicle according to claim 2, further including:
a battery for supplying power to the controller, wherein an accommodation trench is disposed at a top of the fuselage, and the battery is at least partially disposed in the accommodation trench and electrically connected to the controller.

14. The unmanned aerial vehicle according to claim 13, further including:
a power button for turning on or off the unmanned aerial vehicle, wherein the power button is disposed on the battery and electrically connected to the controller.

15. The unmanned aerial vehicle according to claim 13, wherein:
the controller is disposed at a motor board, and the motor board is attached to a bottom of the battery.

16. The unmanned aerial vehicle according to claim 15, wherein:
a heat dissipation plate is disposed at a bottom of the accommodation trench, and the heat dissipation plate is attached to the motor board.

17. The unmanned aerial vehicle according to claim 13, further including:
head indicator lights, configured for indicating a head direction of the unmanned aerial vehicle and disposed at a front portion of the fuselage.

18. The unmanned aerial vehicle according to claim 13, further including:
battery level indicator lights, configured for indicating a battery level and disposed on the battery.

19. The unmanned aerial vehicle according to claim 13, further including:
status indicator lights, configured for indicating a status of the unmanned aerial vehicle and disposed at a rear portion of the fuselage, wherein the status indicator lights flash different colors to indicate different statuses of the unmanned aerial vehicle.

20. The unmanned aerial vehicle according to claim 1, wherein:
the plurality of arm assemblies is disposed at a circumferential side of the fuselage.
